(19) United States
(12) Patent Application Publication
(10) Pub. No.: US 2025/0193959 A1
(43) Pub. Date: Jun. 12, 2025

(54) METHOD FOR SMALL DATA TRANSMISSION IN POWER SAVING STATE AND RELATED DEVICES

(71) Applicant: PURPLEVINE INNOVATION COMPANY LIMITED, Hong Kong (HK)

(72) Inventor: Chiu-Wen CHEN, Hong Kong (HK)

(73) Assignee: PURPLEVINE INNOVATION COMPANY LIMITED, Hong Kong (HK)

(21) Appl. No.: 18/844,953

(22) PCT Filed: Mar. 6, 2023
(86) PCT No.: PCT/CN2023/079799

§ 371 Date: Sep. 7, 2024

Related U.S. Application Data
(60) Provisional application No. 63/317,101, filed on Mar. 7, 2022.

(51) Int. Cl. H04W 76/20; H04W 68/02; H04W 72/232; H04W 74/0833

(52) U.S. Cl. CPC H04W 76/20; H04W 68/02; H04W 72/232; H04W 74/0833

(57) ABSTRACT

A method for small data transmission (SDT) in a power saving state and related devices are provided. The method, performed by a user equipment (UE), includes receiving a SDT configuration in a radio resource control (RRC) signaling; monitoring a downlink (DL) signaling including a mobile terminated (MT) indication in a physical downlink control channel (PDCCH) or paging occasion in the power saving state; and upon reception of the MT indication, receiving DL small data on an associated radio resource based on the SDT configuration without radio resource control (RRC) state transition. With this method, support with MT traffic transmission in the power saving state is realized.

### TECHNICAL FIELD

The present disclosure relates to the field of wireless communications, and more particularly, to a method for small data transmission (SDT) in a power saving state and related devices.

### BACKGROUND ART

Communication systems and networks have developed towards being a broadband and mobile system. In cellular wireless communication systems developed by the Third Generation Partnership Project (3GPP), user equipment (UE) is connected by a wireless link to a radio access network (RAN). The RAN includes a set of base stations (BSs) which provide wireless links to the UEs located in cells covered by the base station, and an interface to a core network (CN) which provides overall network control. As will be appreciated, the RAN and CN each conduct respective functions in relation to the overall network. The 3GPP has developed the so-called Long Term Evolution (LTE) system, namely, an Evolved Universal Mobile Telecommunication System Territorial Radio Access Network (E-UTRAN), for a mobile access network where one or more macro-cells are supported by a base station known as an eNodeB or eNB (evolved NodeB). More recently, evolved from LTE, the so-called 5G or New radio (NR) systems where one or more cells are supported by a base station known as a gNB.

In LTE, the network may order the UE to get into an RRC_IDLE state if the UE has no activity for a while. This is done to reduce UE's power consumption. The UE needs to transit from the RRC_IDLE state to an RRC_CONNECTED state whenever the UE needs to perform some activity. Since small amounts of data have to be sent very frequently in current mobile communication applications, frequent Idle-Connected-Idle transitions increase network signaling load and latency. Therefore, 5G NR has defined a new state called RRC_INACTIVE to reduce network signaling load and latency involved in transiting to RRC_CONNECTED state. In NR, a UE is in RRC_CONNECTED when an RRC connection has been established or in RRC_INACTIVE when the RRC connection is suspended. If this is not the case, the UE is in RRC_IDLE state, that is, no RRC connection is established. The RRC_INACTIVE and RRC_IDLE states may be referred to as a power saving state. More specifically, in RRC_INACTIVE state, the UE Access Stratum (AS) context is stored at both UE and network sides so that the core network connection is maintained (i.e., the UE keeps in CM (abbreviated from Connection Management)-CONNECTED) and the radio access network (RAN) connection is released. The network can reach the inactive UE through RAN or CN Paging messages.

UE performs a random access (RA) procedure to get access to the network. The RA procedure can be a four-step (4-step) procedure or a two-step (2-step) procedure. Taking 4-step contention-based RA procedure for example, the UE transmits a PRACH preamble, also known as MSG1. After detecting the preamble, the gNB responds with a random-access response (RAR), also known as MSG2. The RAR includes an uplink grant for scheduling a PUSCH transmission from the UE known as MSG3. In response to the RAR, the UE transmits MSG3 including an ID for contention resolution. Upon receiving MSG3, the network transmits a contention resolution message, also known as MSG4, with the contention resolution ID. The UE receives MSG4, and if the UE finds its contention-resolution ID it sends an acknowledgement on a PUCCH, which completes the 4-step random access procedure. The 2-step RA procedure is to reduce latency and control signaling overhead by having a single round trip cycle between the UE and the base station. This is achieved by combining the preamble (MSG1) and the scheduled PUSCH transmission (MSG3) into a single message (MSGA) from the UE to the gNB, known as MSGA and by combining the random-access respond (MSG2) and the contention resolution message (MSG4) into a single message (MSGB) from the gNB to UE.

Until 3GPP Rel-16, data transmission is only supported in RRC_CONNECTED state. When a UE stays in RRC_INACTIVE and UL data arrives in TX buffer, the UE has to resume the connection (i.e., move to RRC_CONNECTED state) for data transmission. Connection setup and subsequently release to RRC_INACTIVE state happens for each data transmission. However, for small and infrequent data packets, this results in unnecessary power consumption and signaling overhead. Until 3GPP Rel-17, mobile-oriented small data transmission (SDT) by random access channel (RACH) or configured grant (CG) in power saving state (e.g., RRC_INACTIVE state) is supported for NR system.

3GPP Rel-17 allows mobile-oriented small packet transmission in power saving state. However, for small mobile-terminated (MT) traffic, the legacy mechanism is not applicable since the data radio bearer is not resumed to support data/signaling exchange during power saving state for MT traffic. There is a need to design the operations for MT traffic transmission in power saving state as well.

### SUMMARY

An object of the present disclosure is to propose a method for small data transmission (SDT) in a power saving state and related devices, which can realize mobile terminated (MT) traffic transmission in the power saving state.

In a first aspect of the present disclosure, provided is a method for small data transmission (SDT) in a power saving state, performed by a user equipment (UE) in a network, the method including: receiving a SDT configuration in a radio resource control (RRC) signaling; monitoring a downlink (DL) signaling including a mobile terminated (MT) indication in a physical downlink control channel (PDCCH) or paging occasion in the power saving state; and upon reception of the MT indication, receiving DL small data on an associated radio resource based on the SDT configuration without RRC state transition.

In a second aspect of the present disclosure, provided is a method for small data transmission (SDT) in a power saving state, performed by a base station (BS) in a network, the method including: transmitting to a user equipment (UE) a SDT configuration in a radio resource control (RRC) signaling; transmitting to the UE in the power saving state a downlink (DL) signaling including a mobile terminated (MT) indication in a physical downlink control channel (PDCCH) or paging occasion; and in response to transmitting the MT indication, transmitting DL small data on an associated radio resource based on the SDT configuration without UE RRC state transition.

In a third aspect of the present disclosure, a user equipment includes a memory and a processor coupled to the memory, the processor configured to call and run program instructions stored in a memory, to execute the above method.

In a fourth aspect of the present disclosure, a base station includes a memory and a processor coupled to the memory, the processor configured to call and run program instructions stored in a memory, to execute the above method.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1(a) is a schematic diagram illustrating a communication controlling system according to an embodiment of the present disclosure.

FIG. 1(b) is a block diagram of a user equipment and a base station of wireless communication in a communication controlling system according to an embodiment of the present disclosure.

FIG. 2 is a schematic diagram illustrating radio protocol architecture within gNB and UE for SDT.

FIG. 3 is a schematic diagram illustrating a gNB further including a centralized unit (CU) and a plurality of distributed unit (DUs).

FIG. 4 is a flowchart of a method for small data transmission in a power saving state according to an embodiment of the present disclosure.

FIG. 5(a) is a schematic diagram illustrating an example of MT-SDT DCI according to an embodiment of the present disclosure.

FIG. 5(b) is a schematic diagram illustrating another example of MT-SDT DCI according to an embodiment of the present disclosure.

FIG. 5(c) is a schematic diagram illustrating yet another example of MT-SDT DCI according to an embodiment of the present disclosure.

FIG. 5(d) is a schematic diagram illustrating an example of a field in a paging message according to an embodiment of the present disclosure.

FIG. 6 is a schematic diagram illustrating 2-step MT-SDT based on RA-SDT according to an embodiment of the present disclosure.

FIG. 7 is a schematic diagram illustrating 4-step MT-SDT based on RA-SDT according to an embodiment of the present disclosure.

FIG. 8 is a schematic diagram illustrating MT-SDT based on CG-SDT according to an embodiment of the present disclosure.

FIG. 9 is a flowchart of a SDT procedure according to a first embodiment of the present disclosure.

FIG. 10 is a flowchart of a SDT procedure according to a second embodiment of the present disclosure.

FIG. 11 is a flowchart of a SDT procedure according to a third embodiment of the present disclosure.

FIG. 12 is a flowchart of a SDT procedure according to a fourth embodiment of the present disclosure.

FIG. 13 is a flowchart of a SDT procedure according to a fifth embodiment of the present disclosure.

FIG. 14 is a flowchart of a SDT procedure according to a sixth embodiment of the present disclosure.

FIG. 15 is a flowchart of a SDT procedure according to a seventh embodiment of the present disclosure.

FIG. 16 is a flowchart of a SDT procedure according to an eighth embodiment of the present disclosure.

FIG. 17 is a flowchart of a SDT procedure according to a ninth embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this document, the term “/” should be interpreted to indicate “and/or.” A combination such as “at least one of A, B, or C,” “one or more of A, B, or C,” “at least one of A, B, and C,” “one or more of A, B, and C,” or “A, B, and/or C” may be A only, B only, C only, A and B, A and 30 C, B and C, or A and B and C, where any combination may contain one or more members of A, B, or C.

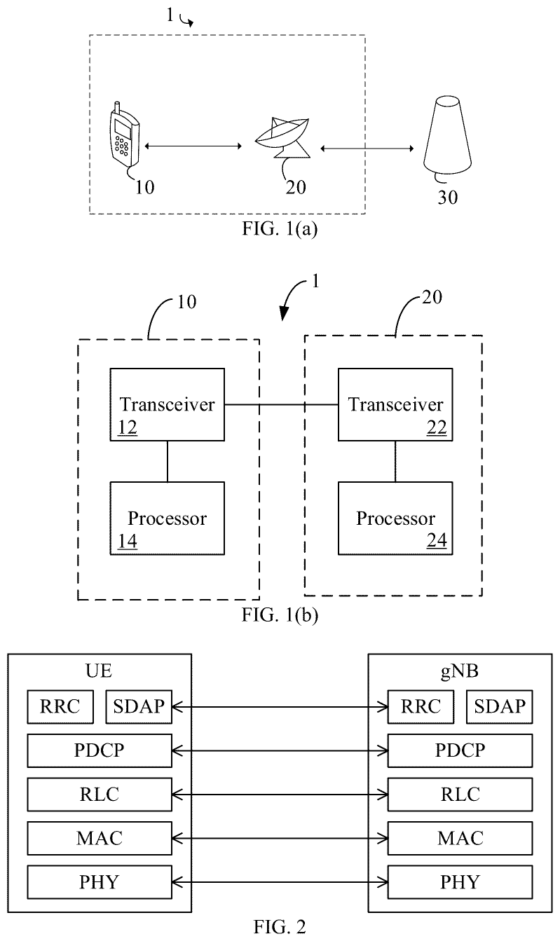

A schematic view and a functional block diagram of a communication controlling system 1 according to the present invention are shown in FIG. 1(a) and FIG. 1(b) respectively. The communication controlling system 1 includes a user equipment 10 and a base station 20. The user equipment 10 and the base station 20 may communicate with each other either wirelessly or in a wired way. The base station 20 and a next generation core network 30 may also communicate with each other either wirelessly or in a wired way. When the communication controlling system 1 complies with the New Radio (NR) standard of the 3rd Generation Partnership Project (3GPP), the next generation core network (5GCN) 30 is a backend serving network system and may include an Access and Mobility Management Function (AMF), User Plane Function (UPF), and a Session Management Function (SMF).

The user equipment 10 includes a transceiver 12 and a processor 14, which are electrically connected with each other. The base station 20 includes a transceiver 22 and a processor 24, which are electrically connected with each other. The transceiver 12 of the user equipment 10 is configured to transmit a signal to the base station 20 (and receive a signal from the base station 20) and the processor 24 of the base station 20 processes the signal, the transceiver 22 of the base station 20 is configured to transmit a signal to the user equipment 10 (and receive a signal from the user equipment 10) and the processor 14 of the user equipment 10 processes the signal. In this way, the user equipment 10 communicates with the base station 20 each other.

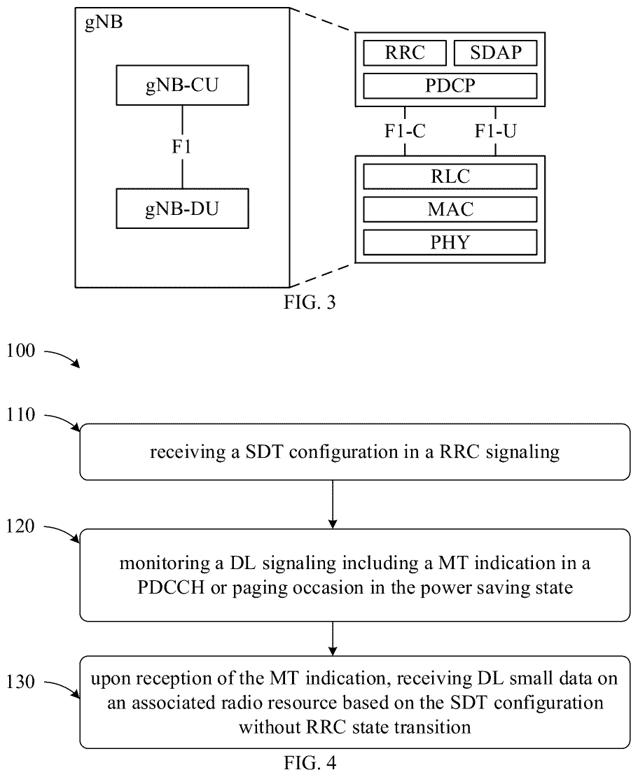

The radio protocol architecture within the base station (gNB) and UE for SDT is shown in FIG. 2, which includes Radio Resource Control (RRC), Service Data Adaptation Protocol (SDAP), Packet Data Convergence Protocol (PDCP), Radio Link Control (RLC), Medium Access Control (MAC). In RAN functional split, the gNB further includes a centralized unit (CU) and a plurality of distributed unit (DUs) as shown in FIG. 3. The protocol stack of CU includes an RRC layer, an optional SDAP layer, and a PDCP layer, while the protocol stack of DU includes an RLC layer, a MAC layer, and a PHY layer. The F1 interface between the CU and DU is established between the PDCP layer of the protocol stack and the RLC layer of the protocol stack.

FIG. 4 illustrates a method 100 for small data transmission in a power saving state according to an embodiment of the present disclosure. The method 100 is performed by a user equipment (UE) in a network. The method 100 may include the following steps.

In step 110, the UE receives a SDT configuration in a radio resource control (RRC) signaling from a network node (e.g., a base station such as gNB). The SDT configuration is to configure the UE to transmit uplink (UL) small data and/or receive downlink (DL) small data in a power saving state (e.g., RRC_INACTIVE). The SDT configuration is received by the UE via RRC signaling, for example, when the UE is in a connected state or transitions from the connected state (e.g., RRC_CONNECTED) to the power saving state (e.g., RRC_INACTIVE). The RRC signaling may be system information or RRCRelease. The SDT configuration may be a DL/UL SDT configuration and may be common for all UEs or UE-specific. The SDT configuration may be on a random access (RA)-SDT or configured grant (CG)-SDT basis. That is, a RA-SDT procedure may be employed for transmission of the DL/UL small data, or the DL small data and the response of the DL small data, in the power saving state. Alternatively, a CG-SDT procedure may be employed for transmission of the DL/UL small data, or the DL small data and the response of the DL small data, in the power saving state. Resource allocation of the DL/UL small data may be configured in the SDT configuration and may be configured while the UE is in the power saving state. In case of RA-SDT, the SDT configuration may include random access channel (RACH) partition for SDT, and a preamble used in the RA-SDT is selected from the RACH partition of the SDT configuration. Preamble partitioning may be defined on a feature (e.g., SDT, slicing) or feature combination (e.g., selected slicing, SDT or not, REDCAP or not) basis, and a mapping between the feature or feature combination and an associated physical random access channel (PRACH) resource set has an association. In case of CG-SDT, UL small data and DL small data may be transmitted on UL CG resources and DL CG resources, respectively. The UL CG resources may also be used for the response of the DL small data.

In step 120, the UE monitors a DL signaling including a mobile terminated (MT) indication in a physical downlink control channel (PDCCH) or paging occasion in the power saving state. The base station may check its buffer, and when there are DL data for the UE and the DL data are applicable to be transmitted in the UE power saving state, the base station will transmit the DL signaling including the MT indication to the UE. While the UE is in the power saving state, the UE will monitor the MT indication in PDCCH or paging occasion for receiving the DL small data. That is, the MT indication is used to indicate the UE that there are DL small data for the UE in the power saving state. The MT indication may include only one bit for indicating there are DL small data for the UE. In addition to the one bit, the MT indication may include additional bits for other information. For example, the MT indication may be associated with resource allocation or scheduling information of the DL small data. In another aspect, resource allocation or scheduling information of the DL small data may be associated with resource allocation of the MT indication. That is, resource allocation of the DL small data is related to resource allocation of the MT indication.

In an embodiment, the DL signaling may be downlink control information (DCI), which includes a short message in which the MT indication is embedded. The DCI may further include scheduling information for the DL small data. The scheduling information may include at least one of carrier indicator, bandwidth part indicator, frequency domain resource assignment, time domain resource assignment, or modulation and coding scheme (MCS). In another aspect, the DCI may include scheduling information of paging and resource allocation of the DL small data may be associated with the transmission of the paging.

In an embodiment, the MT indication may be implemented via paging and embedded in a paging message. In another aspect, transmission of the DL small data may be implicitly following the paging based on a configured MT-SDT period or offset. For example, the configured MT-SDT period or offset may be defined as how many resources in time domain are spaced between the resources of the DL small data and the paging.

In an embodiment, the MT indication may indicate MT-SDT information for the DL small data, and the MT-SDT information may include at least one of one-shot or multi-shot MT-SDT; high or low MT-SDT priority; or RA-SDT or CG-SDT as a baseline for the response of the DL small data. For the one-shot or multi-shot indication, the MT-SDT information may inform the UE that the DL small data will be transmitted in one-time transmission or multiple times of transmissions. For the high or low priority indication, the MT-SDT information may inform the UE the priority of the DL small data transmission. For the RA-SDT or CG-SDT indication, the MT-SDT information may inform the UE whether the RA-SDT or the CG-SDT will be used as a baseline for the response of the DL small data. In another embodiment, each of all the foregoing information may be provided in the SDT configuration. In an exemplary example, the SDT configuration may include an information element (IE) which configures the MT-SDT information, and the MT-SDT information includes at least one of a priority rule or a threshold for the DL small data. The threshold may be a size threshold of the DL small data. For example, when the size of the DL small data is less than the threshold or within a certain range, RA-SDT may be applied. When the size of the DL small data is greater than the threshold or exceeds the certain range, CG-SDT may be applied. The threshold may also be a reference signal received power (RSRP)-based threshold. For example, if the received power of the reference signal by the UE is less than a RSRP threshold, the UE may be located at cell edge, and 4-step RA-SDT may be applied in this scenario in order to ensure reliability of data transmission; and if the received power of the reference signal by the UE is greater than the RSRP threshold, the UE may be located near the center of a cell, and 2-step RA-SDT may be applied in this scenario in order to increase transmission efficiency.

In step 130, upon reception of the MT indication, the UE receives the DL small data on an associated radio resource based on the SDT configuration without RRC state transition. During the power saving state, once the MT indication is received, the UE may wait to receive the DL small data without RRC state transition, that is, the UE stays in the power saving state to receive the DL small data. In some other cases, when the size of the DL small data is too large and it is not appropriate to use the MT-SDT, the UE may transition to the connected state to receive the DL data. The DL small data are received based on the SDT configuration configured by the base station. The SDT configuration may configure the aforesaid threshold of the DL small data or may indicate whether RA-SDT or CG-SDT is applied to the DL small data transmission. In addition, resource allocation or scheduling information of the DL small data may be provided in the SDT configuration. In other cases, resources of the DL small data may be allocated during the power saving state.

In an embodiment, the DL small data may be received based on a MT-SDT procedure using RA-SDT as a baseline. In an exemplary example, 2-step SDT may be involved in the MT-SDT procedure, and RRC signaling response and initial transmission of the DL small data may be multiplexing in MSGB of the 2-step SDT. Subsequent UL/DL small data may be transmitted following MSGB based on a SDT threshold. In another exemplary example, 4-step SDT may be involved in the MT-SDT procedure, and RRC signaling response and initial transmission of the DL small data may be multiplexing in MSG4 of the 4-step SDT. Subsequent UL/DL small data may be transmitted following completion of the initial transmission of the DL small data based on a SDT threshold.

In an embodiment, the DL small data may be received based on a MT-SDT procedure using CG-SDT as a baseline. Further, the response of the DL small data may be transmitted based on the CG-SDT. That is, CG resources for SDT may be used for the response of the DL small data, transmitted from the UE to the base station. In an exemplary example, resource allocation of the MT-SDT for the DL small data may be indicated in the MT indication, as described above. In another exemplary example, resource allocation of the MT-SDT for the DL small data may be associated with a CG-SDT resource configuration. For instance, the SDT configuration may include a CG-SDT configuration IE and a MT-SDT configuration IE, the CG-SDT configuration IE may be used to configure UL SDT without dynamic grant or contention in the power saving state, and the MT-SDT configuration IE may be used to configure DL SDT including MT-SDT resource allocation in the power saving state. In another aspect, resource allocation of the MT-SDT for the DL small data may be implicitly associated with the CG-SDT resource configuration and may be configured within a CG-SDT configuration IE included in the SDT configuration. For example, MT-SDT radio resource is implicitly allocated right before the assignment of CG-SDT resource based on a configured MT-SDT period or offset. For example, the configured MT-SDT period or offset may be defined as how many resources in time domain are spaced between the MT-SDT radio resource and the CG-SDT resource. In some cases, mobile originated (MO) data and MT data may be transmitted via CG-SDT and MT-SDT procedures simultaneously. In some other cases, transmission of UL/DL SDT and associated response/feedback may be sent separately on CG-SDT and MT-SDT radio resources, and UL CG-SDT and MT-SDT response are piggyback in the same packet data unit while DL MT data and CG-SDT feedback are piggyback in the same packet data unit as well.

In an embodiment, there may have a timer (i.e., MT-SDT timer) running on the UE to avoid state mismatch, and the method may further include starting a MT-SDT timer to wait for initial transmission of the DL small data upon reception of the MT indication; and stopping MT-SDT timer at completion of the reception of the DL small data. Upon expiry of the MT-SDT timer, the UE may be unable to receive the DL small data anymore. In addition to the MT-SDT timer, the DL small data may be received based on other timers such as a SDT-time alignment timer (TAT), a CG-SDT timer or a RA-SDT timer. Further, the DL small data may be received based on one or more of the afore-mentioned timers, especially including the MT-SDT timer. The SDT-TAT is used to manage time alignment with the base station and may be started when receiving RRCRelease from the base station. The SDT-TAT is restarted upon reception of a timing advance (TA) Command. When the SDT-TAT is running, it may mean that time synchronization is made between the UE and the base station. As to the CG-SDT timer, the UE transmits UL small data on CG resources in the power saving state while this timer is running. As to RA-SDT timer, the UE transmits UL small data in a random access procedure in the power saving state while this timer is running. In an exemplary example, the MT indication monitoring in step 120 may be performed only if the RA-SDT timer is not running. More specifically, the MT indication monitoring in step 120 may be performed only if the RA-SDT timer is not running but the SDT-TAT is running.

With the proposed method 100 illustrated above, the invention can realize support with mobile terminated (MT) small data transmission (SDT) in a new radio access system (e.g., NR) or next-generation communication, and the infrequent (e.g., periodic and/or non-periodic) small data can be exchanged when a (UE) is in the power saving state.

Further details of the invention are described as follows.

The UL SDT procedure (i.e., RA-SDT and CG-SDT) is introduced to enable UL small data transmission based on the SDT threshold in the RRC_INACTIVE state. For RA-SDT, the UE transmits UL small data using shared radio resources of the random access (e.g., contention-based, contention-free) procedure. The RA-SDT related RA resources are configured via RRC signaling or system information, e.g., SIB1. A common RACH partitioning for NR features should be specified explicitly to reduce UE complexity. In other words, the preamble partitioning is defined on a feature (e.g., SDT, slicing) and/or feature combination (e.g., selected slicing, SDT or not, REDCAP or not) basis. The feature/feature combination specific parameters are configured by the network. The mapping between feature/feature combination and the associated PRACH resource set (i.e., including preambles and RACH occasion) should have an association so that once a preamble on a specific RACH occasion is received, the network can distinguish it without any ambiguity. It means that the UE can select a specific preamble from RACH partitioning for initiating RA-SDT procedure. On the other hand, the RACH partitioning can be configured on BWPs other than initial BWP so that the RA-SDT can be performed on the initial BWP or non-initial BWP (i.e., active or default BWP other than initial BWP). During RA-SDT, the UE monitors the PDCCH addressed to the Radio Network Temporary Identifier (e.g., Small Data Transmission-RNTI (SDT-RNTI), Temporary Cell-RNTI (TC-RNTI), Inactive-RNTI (I-RNTI), Paging-RNTI (P-RNTI), Cell-RNTI (C-RNTI), Configured Scheduling-RNTI (CS-RNTI), etc.) for the upcoming events (e.g., initial/subsequent DL data transmission, retransmission, system information change, emergency service) no matter the RA-SDT timer is running. If the association between RA-SDT preambles and BWPs is configured, the specific preamble would be chosen for MSGA/MSG1 of 2-step/4-step RA-SDT on the specific SDT BWP. The RA-SDT timer would be started upon the transmission of RRCResumeRequest. Then the MSGB/MSG2 of 2-step/4-step RA-SDT would be received on the associated SDT BWP upon the transmission of MSGA/MSG1. The RA-SDT timer would be stopped upon the reception of DL response (e.g., RRCSetup, RRCResume, RRCReject). If the RA-SDT timer is not running, the UE should monitor an indication (e.g., SI change indication, PWS indication, MT indication) in any paging occasion on the associated active BWP.

For CG-SDT, the related resource configuration is provided to the UE in RRC_CONNECTED state via the RRC signaling (e.g., RRCRelease with suspendConfig). The RSRP-based TA validation shall be applied for initial UL SDT procedure. It means when the CG-TAT is running and valid, the configured CG-SDT resources can be used for initial CG-SDT. Upon expiry of CG-TAT, the UE may clear all the SDT configured grant and flush SDT HARQ buffer. The UE-specific search space is configured for the UE(s) to perform CG-SDT procedure. The UE is allowed to initiate the subsequent UL data transmission upon the reception of initial SDT acknowledgement from the network. During CG-SDT, the UEs should monitor PDCCH scrambled by SDT-RNTI, C-RNTI, I-RNTI, P-RNTI, or CS-RNTI in the provided UE-specific common search space for receiving SI change indication/PWS indication/MT indication through dedicated signaling. A CG-SDT timer is used for prohibiting the HARQ process running with a new uplink transmission. When the CG-SDT timer is running, a new CG-SDT cannot use the same HARQ process. The CG-SDT timer for initial transmission should be stopped when PDCCH addressed to the UE-specific RNTI (e.g., C-RNTI and CS-RNTI) is received. When the CG-SDT timer expires, the UE is allowed to initiate a new CG-SDT with the same HARQ process. If the associated BWP (i.e., non-initial BWP) is configured for SDT, after initiating SDT, the UE needs to monitor PDCCH/paging occasion for system information change, emergency service, or special events (e.g., DL data arrival, retransmission) on the associated BWP.

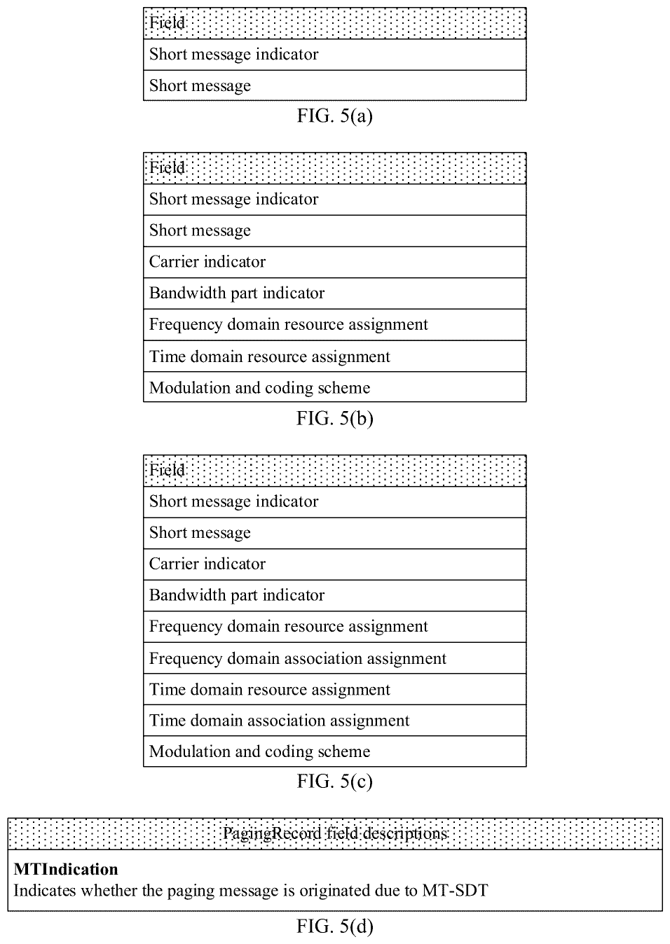

In addition to the UL small data transmission, during the SDT procedure (i.e., while the SDT-TAT timer is running), the UE needs to monitor PDCCH/paging for initial/subsequent DL data transmission, retransmission, system information change, public warning indication, and so on. The UE monitors an indication in any PDCCH/paging occasion on the associated active BWP. If there is an indication for the UE for the non-SDT DL data arrival during an SDT session, the network can indicate the UE to resume the connection and fallback to RRC_CONNECTED state. If there is an initial DL small data arrival for the UE while the RA-SDT or the CG-SDT timer is not running, the UE can perform a Mobile Terminated (MT) small data reception procedure without state transition. Here a Mobile Terminated-Small Data Transmission (MT-SDT) procedure triggered by the network for RRC_INACTIVE state is proposed in this disclosure. The UE can perform MT-SDT upon the reception of MT indication embedded in a DL signaling (e.g., DCI, paging). If the MT indication is implemented via DCI, a DCI format (e.g., DCI format 1_0) with CRC scrambled by a Radio Network Temporary Identifier (e.g., SDT-RNTI, C-RNTI, I-RNTI, P-RNTI, or CS-RNTI) is used to indicate and schedule MT-SDT for the UE(s). For example, a MT-SDT DCI with CRC scrambled by P-RNTI/C-RNTI can be used to indicate and schedule not only paging but the MT-SDT for the UE(s). The MT-SDT DCI may include at least one of short message indicator, short message, time/frequency scheduling information and MCS for MT-SDT. The content of MT-SDT DCI is shown as at least one of FIG. 5(a) to FIG. 5(c).

In FIG. 5(a), the MT-SDT DCI indicates only MT indication for indication of MT data arriving. In some cases, the MT-SDT DCI may further indicate the scheduling information of paging (not shown). The UE would perform RA-SDT procedure as the UL response. The following is an example of FIG. 5(a) but not limited to:
The short message indicator may indicate only short messages is present in the DCI.
Short message may indicate the MT indication for indication of MT data arriving.

In FIG. 5(b), both the MT indication and the scheduling information of MT-SDT are present in the MT-SDT DCI. The RA-SDT or CG-SDT procedure would be performed as the UL response. The following is an example of FIG. 5(b) but not limited to:
The short message indicator may indicate the scheduling information for MT-SDT and short messages are present in the DCI
Short message may indicate the MT indication for indication of MT data arriving
Carrier indicator may indicate the cross-carrier scheduling for MT-SDT
Bandwidth part indicator may indicate the BWP in which the MT-SDT frequency resources are located, excluding the initial DL BWP.
Frequency domain resource assignment may indicate the MT-SDT resource allocation on frequency domain
Time domain resource assignment may indicate the MT-SDT resource allocation on time domain
Modulation and coding scheme (MCS) may indicate the MCS of MT-SDT

In FIG. 5(c), in addition to MT indication, the scheduling information of MT-SDT associated with the transmission of paging are present in the MT-SDT DCI. The UE would perform CG-SDT procedure as the UL response. The following is an example of FIG. 5(c) but not limited to:
The short message indicator may indicate the scheduling information for Paging, MT-SDT and short messages are present in the DCI
Short message may indicate the MT indication for indication of MT data arriving
Carrier indicator may indicate the cross-carrier scheduling for MT-SDT
Bandwidth part indicator may indicate the BWP in which the MT-SDT frequency resources are located, excluding the initial DL BWP.
Frequency domain resource assignment may indicate the paging resource allocation on frequency domain
Frequency domain association assignment may indicate the MT-SDT resource allocation which is associated with the transmission of paging on frequency domain
Time domain resource assignment may indicate the paging resource allocation on time domain
Time domain association assignment may indicate the MT-SDT resource allocation which is associated with the transmission of paging on time domain
Modulation and coding scheme (MCS) may indicate the MCS of MT-SDT

In an alternative implementation, the MT indication is implemented via paging (i.e., RAN Notification Area (RNA) paging and/or CN paging). At least one MT indication bit/field is described in paging message. AMT indication may be included in the PagingRecord field as shown in FIG. 5(d), but not limited to. The paging message indicated by a Radio Network Temporary Identifier (e.g., SDT-RNTI, C-RNTI, I-RNTI, P-RNTI, or CS-RNTI) scrambled with the paging DCI. Once the UE detects such the DCI, it decodes the corresponding PDSCH resource to extract the MT indication within the paging message. Here the MT indication may be more than one bit (not shown). The various MT-SDT information can be indicated by the MT indication. For example, one-shot or multi-shot MT-SDT would be indicated; high or low MT-SDT priority would be indicated; preferred contention-based or contention-free MT-SDT would be indicated, and so on. Based on the MT indication information, the UE can realize which procedure would be performed for the initial MT-SDT reception and subsequent UL/DL data transmissions. In other words, the UE would perform RA-SDT/CG-SDT/normal RACH procedure as the UL response.

If the MT data is applicable to the MT-SDT, the UE can receive the initial downlink (DL) small data without transitioning to RRC_CONNECTED state. There are two types of MT-SDT procedure in RRC_INACTIVE state as follows:
Contention-based MT-SDT: RA-SDT is the baseline for the response of small MT data transmission.
Contention-free MT-SDT: CG-SDT is the baseline for the response of small MT data transmission.

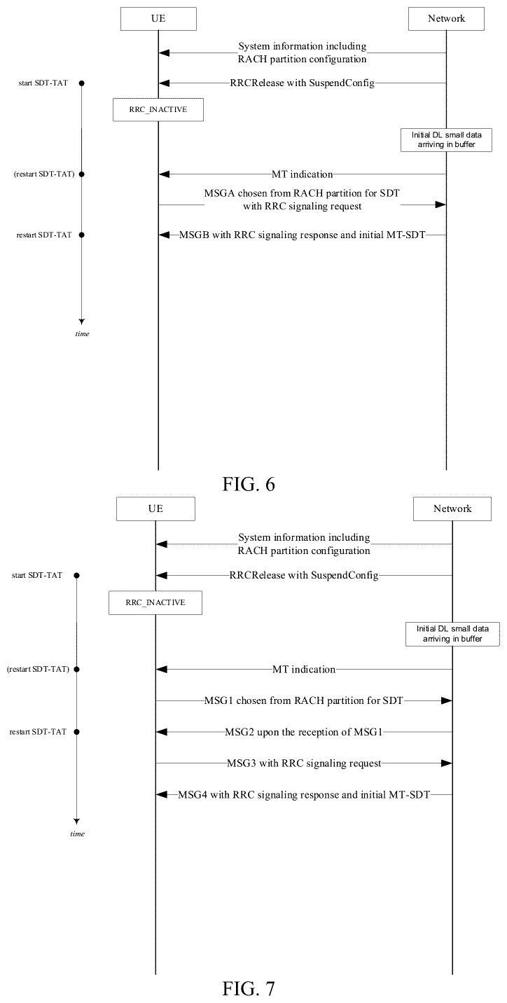

For contention-based MT-SDT, the RA-SDT procedure is supported as the UL response. The 2-step MT-SDT and 4-step MT-SDT are based on RA-SDT as shown in FIG. 6 and FIG. 7 respectively. The SDT resource configuration including RACH partition for SDT are provided to the UEs within system information and RRC signaling (e.g., RRCRelease with SuspendConfig IE). The SDT-TAT is started upon the reception of SDT resource configuration from the network (e.g., RRCRelease with SuspendConfig IE) and is restarted upon the reception of TA command. For example, the SDT-TAT is restarted upon the reception of TA Command multiplexed in MSG2/DL signaling (e.g., PDCCH, paging, MT data). When the RA-SDT timer is not running but the SDT-TAT is running, the UE should monitor MT indication for MT-SDT. In FIG. 6, the selected SDT preamble from RACH partition configuration and RRC signaling request (e.g., RRCResumeRequest) are multiplexing in MSGA upon the reception of MT indication from the network. RRC signaling response (e.g., RRCSetup, RRCResume, RRCReject) and the initial small MT data are multiplexing in MSGB. The subsequent UL/DL small data can be transmitted following MSGB based on SDT threshold (e.g., SDT volume threshold, RSRP-based threshold(s), MT-SDT threshold). The UE may perform the 4-step RACH fallback procedure once the transmission of MSGA is failed (e.g., no response after transmitting MSGA). In FIG. 7, the selected SDT preamble from RACH partition configuration is transmitted in MSG1 upon the reception of MT indication from the network. The SDT-TAT is restarted upon the reception of TA Command within the MSG2. The RRC signaling request (e.g., RRCResumeRequest) is transmitted in MSG3. RRC signaling response (e.g., RRCSetup, RRCResume, RRCReject) and the initial small MT data are multiplexing in MSG4. The subsequent UL/DL small data can be transmitted following the completion of initial MT-SDT based on SDT threshold (e.g., SDT volume threshold, RSRP-based threshold(s), MT-SDT threshold). The UE may perform the RACH fallback procedure (i.e., transit to RRC_CONNECTED) once the failed MT-SDT reception (i.e., no MT data multiplexed in MSG4).

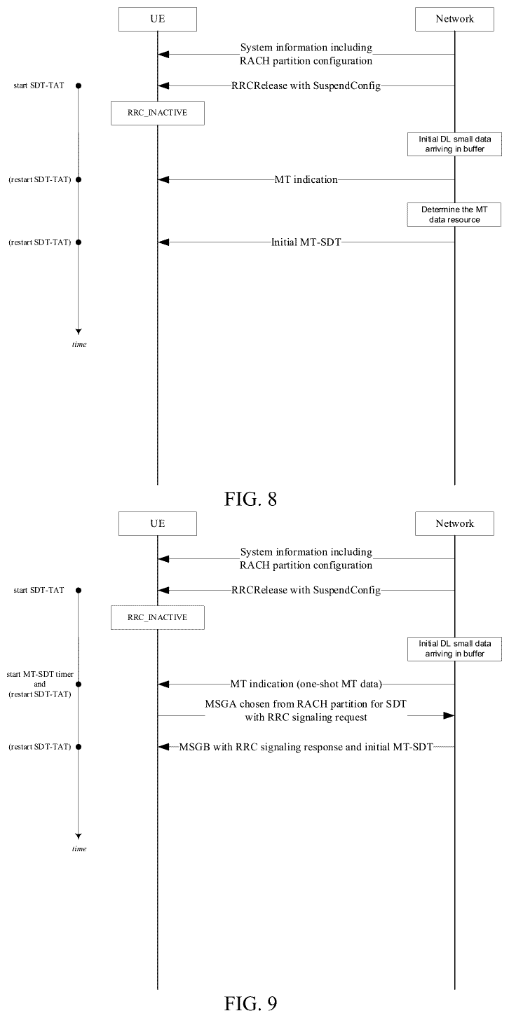

For contention-free MT-SDT, the CG-SDT procedure is supported as the UL response. The initial MT-SDT is transmitted based on CG-SDT as shown in FIG. 8. The SDT resource configuration is provided to the UEs within system information and RRC signaling (e.g., RRCRelease with SuspendConfig IE). The SDT-TAT is started upon the reception of SDT resource configuration from the network (e.g., RRCRelease with SuspendConfig IE) and is restarted upon the reception of TA command. For example, the SDT-TAT is restarted upon the reception of TA Command multiplexed in DL signaling (e.g., PDCCH, paging, MT data). When the SDT-TAT is running, the UE should monitor MT indication for MT-SDT. The CG-SDT timer is stopped upon the reception of MT indication. In FIG. 8, the initial MT data for MT-SDT should be transmitted on the MT-SDT radio resource following the transmission of MT indication from the network. The UE monitors and detects the MT-SDT radio resource upon the reception of MT indication. The MT-SDT radio resource allocation may be associated with MT indication (i.e., DCI or paging) or CG-SDT resource configuration. Embodiments described herein present the scheduling information of MT-SDT is associated with the resource allocation of MT indication as shown in FIG. 5(b) and FIG. 5(c). In an alternative implementation (not shown), the transmission of initial MT-SDT is implicitly following paging based on a configured MT-SDT period/offset. The MT-SDT period/offset can be configured within system information and RRC signaling (e.g., RRCRelease with SuspendConfig IE). The UE can predict and receive the initial MT data on the MT-SDT radio resource based on the paging and the MT-SDT period/offset.

On the other hand, the resource allocation of MT-SDT and CG-SDT can be explicitly pre-configured in advance (e.g., in RRC_CONNECTED). The CG-SDT configuration information element (IE) (e.g., ConfiguredGrantConfig) is used to configure UL SDT without dynamic grant or contention in RRC_INACTIVE. A MT-SDT configuration IE is used to configure DL SDT including MT-SDT resource allocation in RRC_INACTIVE. In some cases, some MT-SDT information (e.g., MT-SDT priority rule, MT-SDT threshold) can be configured in the MT-SDT configuration IE. In another alternative implementation, the resource allocation of MT-SDT is implicitly associated with CG-SDT resource configuration and is optional configured within the CG-SDT configuration IE. For example, the MT-SDT radio resource can be implicitly allocated right before the assignment of CG-SDT resource based on a configured NIT-SDT period/offset. The MT-SDT period/offset can be configured within system information and RRC signaling (e.g., RRCRelease with SuspendConfig IE, ConfiguredGrantConfig). The UE can predict and receive the initial MT dada on the MT-SDT radio resource based on the CG-SDT and the MT-SDT period/offset.

For TDM/FDM operation, the initial MT data would be better transmitted before the resource assignment of CG-SDT so that the UE can perform CG-SDT as the UL response immediately. In some cases, to avoid the state mismatch, the UE starts a MT-SDT timer to wait for the initial MT data upon the reception of MT indication. The MT-SDT timer would be stopped at the completion of MT-SDT. Upon the expiration of MT-SDT timer, the UE would perform RA-SDT or fallback to RRC_CONNECTED for receiving the MT data. In some further cases, the network would retransmit the MT indication via CN paging to re-trigger the MT-SDT upon the expiration of MT-SDT timer.

A first embodiment of the present disclosure is as shown in FIG. 9, which depicts implementation scenarios of MT-SDT between the UE 10 and the base station 20 according to the present disclosure. This embodiment is directed to one-shot MT-SDT via 2-step RACH. In FIG. 9, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the RA-SDT timer is not running but the SDT-TAT is running, the UE should monitor MT indication as specified in FIG. 5 for MT-SDT. Upon the reception of MT indication from the network, a MT-SDT timer is started, and the SDT-TAT may be restarted. According to the received MT indication and SDT threshold, the UE determines to perform 2-step RA-SDT as the UL response while the contention-based MT-SDT is initiated. The selected SDT preamble from RACH partition configuration and RRC signaling request (e.g., RRCResumeRequest) are multiplexed in MSGA to the network. The RRC signaling response (e.g., RRCReject) and the initial MT data are multiplexed in MSGB to the UE. Upon the expiration of MT-SDT timer, the UE would perform fallback RACH to RRC_CONNECTED for receiving the MT data. In other words, the UE may perform the 4-step RACH fallback procedure once the transmission of MSGA/MSGB is failed (e.g., upon the expiration of MT-SDT timer, no response after transmitting MSGA). In some cases (e.g., no reception of the expected MSGA), the network would retransmit the MT indication via CN paging to re-trigger the MT-SDT during the running of MT-SDT timer and/or SDT-TAT.

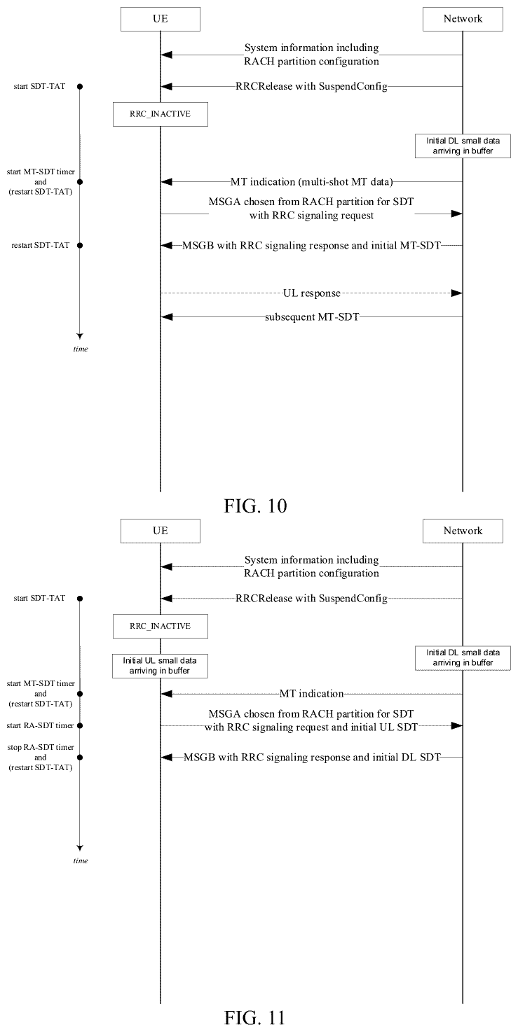

A second embodiment of the present disclosure is as shown in FIG. 10, which depicts implementation scenarios of MT-SDT between the UE 10 and the base station 20 according to the present disclosure. This embodiment is directed to multi-shot MT-SDT via 2-step RACH. In FIG. 10, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the RA-SDT timer is not running but the SDT-TAT is running, the UE should monitor MT indication as specified in FIG. 5 for MT-SDT. Upon the reception of MT indication from the network, a MT-SDT timer is started, and the SDT-TAT may be restarted. According to the received MT indication and SDT threshold, the UE determines to perform 2-step RA-SDT as the UL response while the contention-based MT-SDT is initiated. The operations of 2-step RA-SDT and contention-based MT-SDT are similar as those described in the aforesaid embodiments and hence are not repeated. If the MT indication indicates multi-shot MT-SDT would be transmitted, the subsequent UL/DL small data can be transmitted following MSGB. The subsequent UL response can be RA-SDT or CG-SDT depending on the SDT threshold (e.g., SDT volume threshold, RSRP-based threshold(s)). If there is only subsequent MT data willing to transmit for the UE, the contention-based or contention-free MT-SDT procedure can be performed for the subsequent MT-SDT based on the network's preference specified in MT indication.

A third embodiment of the present disclosure is as shown in FIG. 11, which depicts implementation scenarios of MT-SDT between the UE 10 and the base station 20 according to the present disclosure. This embodiment is directed to MT-SDT via 2-step RA-SDT. In FIG. 11, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the RA-SDT timer is not running but the SDT-TAT is running, the UE should monitor MT indication as specified in FIG. 5 for MT-SDT. Upon the reception of MT indication from the network, a MT-SDT timer is started, and the SDT-TAT may be restarted. If there is an initial UL small data arriving in UL buffer during the reception of MT indication, the UE determines to perform 2-step RA-SDT while the contention-based MT-SDT is initiated according to the SDT threshold (e.g., SDT volume threshold, RSRP-based threshold(s)) and the received MT indication. The operations of 2-step RA-SDT and contention-based MT-SDT are similar as those described in the aforesaid embodiments and hence are not repeated. A RA-SDT timer is started upon the transmission of RRCResumeRequest and is stopped upon the reception of DL response (e.g., RRCSetup, RRCResume, RRCReject). In this case, the Mobile Originated (MO) data and MT data can be transmitted via RA-SDT and MT-SDT procedures simultaneously. The UL SDT and DL SDT is in principle the separate HARQ processes.

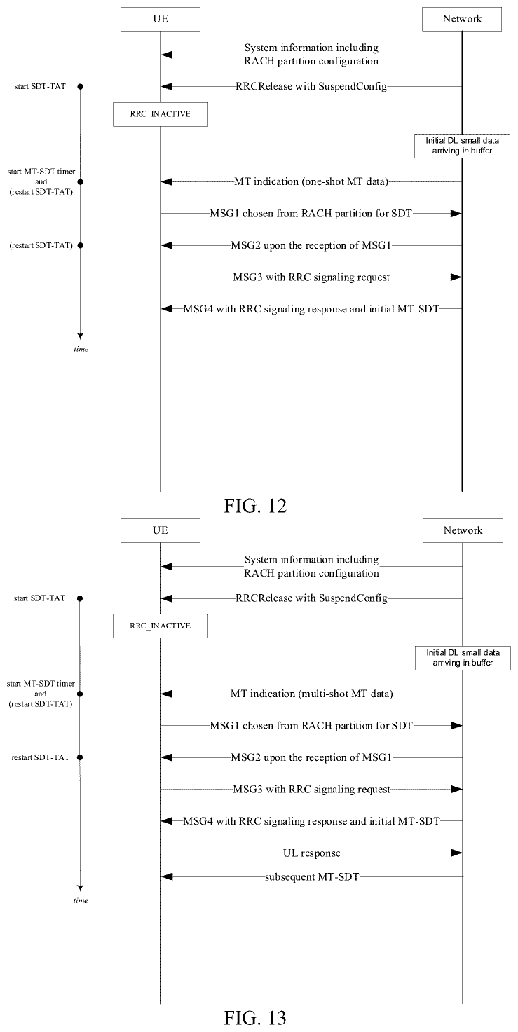

A fourth embodiment of the present disclosure is as shown in FIG. 12, which depicts implementation scenarios of MT-SDT between the UE 10 and the base station 20 according to the present disclosure. This embodiment is directed to one-shot MT-SDT via 4-step RACH. In FIG. 12, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the RA-SDT timer is not running but the SDT-TAT is running, the UE should monitor MT indication as specified in FIG. 5 for MT-SDT. Upon the reception of MT indication from the network, a MT-SDT timer is started, and the SDT-TAT may be restarted. According to the received MT indication and SDT threshold, the UE determines to perform 4-step RA-SDT as the UL response while the contention-based MT-SDT is initiated. The selected SDT preamble from RACH partition configuration is transmitted in MSG1 upon the reception of MT indication from the network. The SDT-TAT is restarted upon the reception of TA Command within the MSG2. The RRC signaling request (e.g., RRCResumeRequest) is transmitted in MSG3. RRC signaling response (e.g., RRCSetup, RRCResume, RRCReject) and the initial small MT data are multiplexing in MSG4. Upon the expiration of MT-SDT timer, the UE would perform fallback to RRC_CONNECTED for receiving the MT data. In other words, the UE may propose the connection resumption once no MT data multiplexed in MSG4. In some cases (e.g., no response from the UE), the network would retransmit the MT indication via CN paging to re-trigger the MT-SDT during the running of MT-SDT timer and/or SDT-TAT.

A fifth embodiment of the present disclosure is as shown in FIG. 13, which depicts implementation scenarios of MT-SDT between the UE 10 and the base station 20 according to the present disclosure. This embodiment is directed to multi-shot MT-SDT via 4-step RACH. In FIG. 13, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the RA-SDT timer is not running but the SDT-TAT is running, the UE should monitor MT indication as specified in FIG. 5 for MT-SDT. Upon the reception of MT indication from the network, a MT-SDT timer is started, and the SDT-TAT may be restarted. According to the received MT indication and SDT threshold, the UE determines to perform 4-step RA-SDT as the UL response while the contention-based MT-SDT is initiated. The operations of 4-step RA-SDT and contention-based MT-SDT are similar as those described in the aforesaid embodiments and hence are not repeated. If the MT indication indicates multi-shot MT-SDT would be transmitted, the subsequent UL/DL small data can be transmitted following the completion of initial MT-SDT (i.e., MSG4). The subsequent UL response can be RA-SDT or CG-SDT based on the SDT threshold (e.g., SDT volume threshold, RSRP-based threshold(s)). If there is only subsequent MT data willing to transmit for the UE, the contention-based or contention-free MT-SDT procedure can be performed for the subsequent MT-SDT based on the network's preference specified in MT indication.

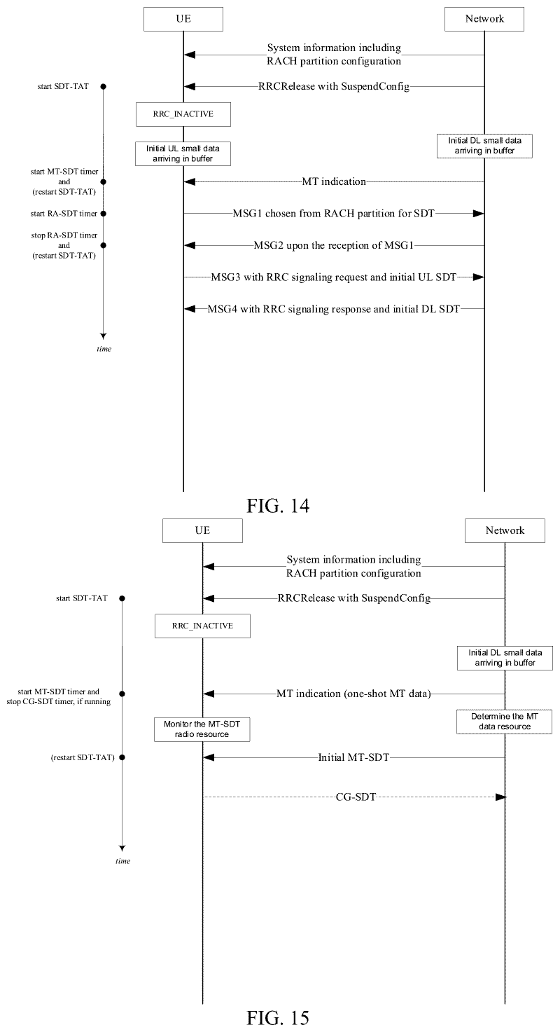

A sixth embodiment of the present disclosure is as shown in FIG. 14, which depicts implementation scenarios of MT-SDT between the UE 10 and the base station 20 according to the present disclosure. This embodiment is directed to MT-SDT via 4-step RA-SDT. In FIG. 14, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the RA-SDT timer is not running but the SDT-TAT is running, the UE should monitor MT indication as specified in FIG. 5 for MT-SDT. Upon the reception of MT indication from the network, a MT-SDT timer is started, and the SDT-TAT may be restarted. If there is an initial UL small data arriving in UL buffer during the reception of MT indication, the UE determines to perform 4-step RA-SDT while the contention-based MT-SDT is initiated according to the SDT threshold (e.g., SDT volume threshold, RSRP-based threshold(s)) and the received MT indication. The operations of 4-step RA-SDT and contention-based MT-SDT are similar as those described in the aforesaid embodiments and hence are not repeated. A RA-SDT timer is started upon the transmission of RRCResumeRequest and is stopped upon the reception of DL response (e.g., RRCSetup, RRCResume, RRCReject). In this case, the MO data and MT data can be transmitted via RA-SDT and MT-SDT procedures simultaneously. The UL SDT and DL SDT is in principle the separate HARQ processes.

A seventh embodiment of the present disclosure is as shown in FIG. 15, which depicts implementation scenarios of MT-SDT between the UE 10 and the base station 20 according to the present disclosure. This embodiment is directed to one-shot MT-SDT via contention-free resource transmission. In FIG. 15, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the SDT-TAT is running, the UE should monitor MT indication as specified in FIG. 5 for MT-SDT. Upon the reception of MT indication from the network, a CG-SDT timer is stopped, a MT-SDT timer is started, and the SDT-TAT may be restarted. According to the received MT indication and SDT threshold, the UE determines to perform CG-SDT as the UL response while the contention-free MT-SDT is initiated. The initial MT data for MT-SDT should be transmitted on the MT-SDT radio resource following the transmission of MT indication from the network. The MT-SDT radio resource allocation is associated with MT indication (i.e., DCI or paging) or CG-SDT resource configuration as described in the aforesaid specification. The UE can explicitly or implicitly monitor/receive the initial MT data on the MT-SDT radio resource based on the resource allocation of PDCCH, paging, or CG-SDT, and the MT-SDT period/offset. The initial MT data would be transmitted before the closest resource assignment of CG-SDT so that the UE can perform CG-SDT as the UL response if necessary. In some cases, the initial MT data would be transmitted following the paging.

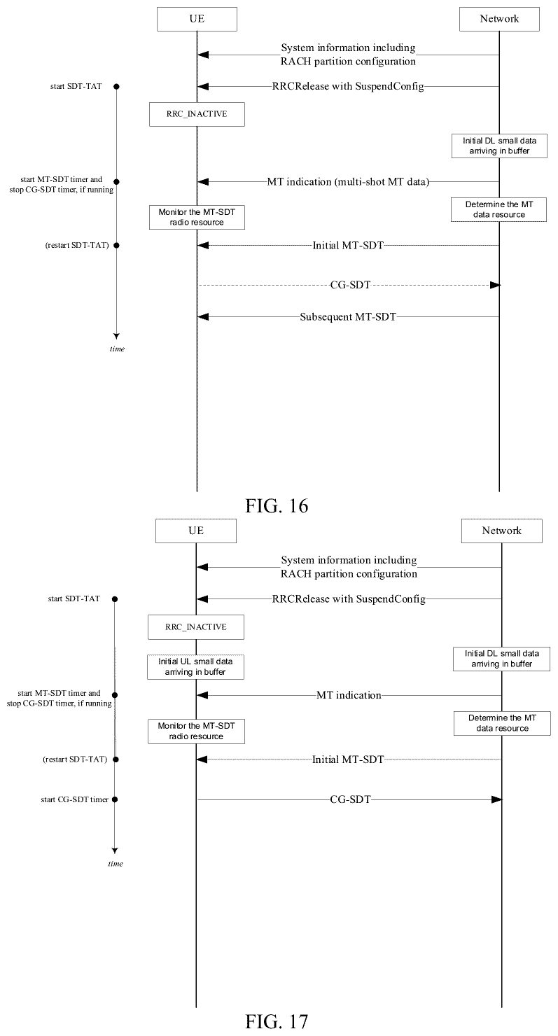

An eighth embodiment of the present disclosure is as shown in FIG. 16, which depicts implementation scenarios of MT-SDT between the UE 10 and the base station 20 according to the present disclosure. This embodiment is directed to multi-shot MT-SDT via contention-free resource transmission. In FIG. 16, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the SDT-TAT is running, the UE should monitor MT indication as specified in FIG. 5 for MT-SDT. Upon the reception of MT indication from the network, a CG-SDT timer is stopped, a MT-SDT timer is started, and the SDT-TAT may be restarted. According to the received MT indication and SDT threshold, the UE determines to perform CG-SDT as the UL response while the contention-free MT-SDT is initiated. The operations of CG-SDT and contention-free MT-SDT are similar as those described in the aforesaid embodiments and hence are not repeated. If the MT indication indicates multi-shot MT-SDT would be transmitted, the subsequent UL/DL small data can be transmitted following the initial MT-SDT. The subsequent UL response can be RA-SDT or CG-SDT depending on the SDT threshold (e.g., SDT volume threshold, RSRP-based threshold(s)). If there is only subsequent MT data willing to transmit for the UE, the contention-based or contention-free MT-SDT procedure can be performed for the subsequent MT-SDT based on the network's preference specified in MT indication.

A ninth embodiment of the present disclosure is as shown in FIG. 17, which depicts implementation scenarios of MT-SDT between the UE 10 and the base station 20 according to the present disclosure. This embodiment is directed to MT-SDT via CG-SDT. In FIG. 17, the common/UE-specific SDT configuration including RACH partition for SDT are provided to the UEs within system information and RRC signaling (e.g., RRCRelease with SuspendConfig IE). The SDT-TAT is started upon the reception of SDT-TAT configuration from the network (i.e., RRCRelease) and is restarted upon the reception of TA command. When the SDT-TAT is running, the UE should monitor MT indication as specified in FIG. 5 for MT-SDT. Upon the reception of MT indication from the network, a CG-SDT timer is stopped, a MT-SDT timer is started, and the SDT-TAT may be restarted. If there is an initial UL small data arriving in UL buffer during the reception of MT indication, the UE determines to perform CG-SDT and the contention-free MT-SDT is initiated according to the SDT threshold (e.g., SDT volume threshold, RSRP-based threshold(s)) and the received MT indication. The operations of CG-SDT and contention-free MT-SDT are similar as those described in the aforesaid embodiments and hence are not repeated. The CG-SDT timer is started upon the transmission of CG-SDT (i.e., for the corresponding HARQ process) and is stopped upon the reception of DL response/feedback (i.e., for the corresponding HARQ process). In this case, the MO data and MT data can be transmitted via CG-SDT and MT-SDT procedures simultaneously. The UL SDT and DL SDT is in principle the separate HARQ processes. It means that the transmission of UL/DL SDT and the associated response/feedback can be sent separately on CG-SDT and MT-SDT radio resources. In some cases, the UL CG-SDT and the MT-SDT response can be piggyback in the same packet data unit while the DL MT data and the CG-SDT feedback can be piggyback in the same packet data unit as well.

In accordance with another aspect of the present disclosure, when MT data is transparent from NAS layer, the network would initiate the UE context resume procedure for reactivating the NAS connection. Based on the aforesaid embodiments, if the network is a RAN functional split node(s), the UL/DL SDT can be transparent between Central Unit (CU) and Distributed Unit(s) (DU(s)) via F1 interface and signaling.

In accordance with another aspect of the present disclosure, when the MT-SDT is supported for CA duplication, the SDT-TAT of Secondary Timing Advance Group (sTAG) shall be maintained by the serving cell and the UE.

In accordance with another aspect of the present disclosure, when SDT in RRC_INACTIVE state is considered on Bandwidth Part (BWP) adaptation, the network is configured with one or multiple BWPs. There is one or more specific BWPs (e.g., initial, default, activated BWP(s)) configured to transmit SDT in RRC_INACTIVE state. The BWP switching for the RA-SDT and contention-based MT-SDT are used while transmitting SDT in RRC_INACTIVE state. The UL/DL data can be transmitted on the associated BWP according to the same UL/DL BWP bwp-Identifier/linkage.

The main advantages of the disclosed methods at least include:
Both CG-SDT and RA-SDT are supported
Lower signaling overhead for data transmission
Lower power consumption for UE
Better resource allocation for network
Lower latency MT small data transmission in RRC_INACTIVE without state transition
Suitable for small and infrequent data transmission such as positioning, machine-type communication applications

Commercial interests for some embodiments are as follows. 1. solving issues in the prior art. 2. better resource efficiency for 5G networks. 3. improving resource efficiency. 4. providing a good communication performance. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR unlicensed band communications. Some embodiments of the present disclosure propose technical mechanisms.

The embodiment of the present application further provides a computer readable storage medium for storing a computer program. The computer readable storage medium enables a computer to execute corresponding processes implemented by the UE/BS in each of the methods of the embodiment of the present disclosure. For brevity, details will not be described herein again.

The embodiment of the present application further provides a computer program product including computer program instructions. The computer program product enables a computer to execute corresponding processes implemented by the UE/BS in each of the methods of the embodiment of the present disclosure. For brevity, details will not be described herein again.

The embodiment of the present application further provides a computer program. The computer program enables a computer to execute corresponding processes implemented by the UE/BS in each of the methods of the embodiment of the present disclosure. For brevity, details will not be described herein again.

Although not shown in detail any of the devices or apparatus that form part of the network may include at least a processor, a storage unit and a communications interface, wherein the processor unit, storage unit, and communications interface are configured to perform the method of any aspect of the present invention. Further options and choices are described below.

The signal processing functionality of the embodiments of the invention especially the gNB and the UE may be achieved using computing systems or architectures known to those who are skilled in the relevant art. Computing systems such as, a desktop, laptop or notebook computer, hand-held computing device (PDA, cell phone, palmtop, etc.), mainframe, server, client, or any other type of special or general purpose computing device as may be desirable or appropriate for a given application or environment can be used. The computing system can include one or more processors which can be implemented using a general or special-purpose processing engine such as, for example, a microprocessor, microcontroller or other control module.

The computing system can also include a main memory, such as random access memory (RAM) or other dynamic memory, for storing information and instructions to be executed by a processor. Such a main memory also may be used for storing temporary variables or other intermediate information during execution of instructions to be executed by the processor. The computing system may likewise include a read only memory (ROM) or other static storage device for storing static information and instructions for a processor.

The computing system may also include an information storage system which may include, for example, a media drive and a removable storage interface. The media drive may include a drive or other mechanism to support fixed or removable storage media, such as a hard disk drive, a floppy disk drive, a magnetic tape drive, an optical disk drive, a compact disc (CD) or digital video drive (DVD) read or write drive (R or RW), or other removable or fixed media drive. Storage media may include, for example, a hard disk, floppy disk, magnetic tape, optical disk, CD or DVD, or other fixed or removable medium that is read by and written to by media drive. The storage media may include a computer-readable storage medium having particular computer software or data stored therein.

In alternative embodiments, an information storage system may include other similar components for allowing computer programs or other instructions or data to be loaded into the computing system. Such components may include, for example, a removable storage unit and an interface, such as a program cartridge and cartridge interface, a removable memory (for example, a flash memory or other removable memory module) and memory slot, and other removable storage units and interfaces that allow software and data to be transferred from the removable storage unit to computing system.

The computing system can also include a communications interface. Such a communications interface can be used to allow software and data to be transferred between a computing system and external devices. Examples of communications interfaces can include a modem, a network interface (such as an Ethernet or other NIC card), a communications port (such as for example, a universal serial bus (USB) port), a PCMCIA slot and card, etc. Software and data transferred via a communications interface are in the form of signals which can be electronic, electromagnetic, and optical or other signals capable of being received by a communications interface medium.

In this document, the terms ‘computer program product’, ‘computer-readable medium’ and the like may be used generally to refer to tangible media such as, for example, a memory, storage device, or storage unit. These and other forms of computer-readable media may store one or more instructions for use by the processor including the computer system to cause the processor to perform specified operations. Such instructions, generally referred to as ‘computer program code’ (which may be grouped in the form of computer programs or other groupings), when executed, enable the computing system to perform functions of embodiments of the present invention. Note that the code may directly cause a processor to perform specified operations, be compiled to do so, and/or be combined with other software, hardware, and/or firmware elements (e.g., libraries for performing standard functions) to do so.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory. In an embodiment where the elements are implemented using software, the software may be stored in a computer-readable medium and loaded into computing system using, for example, removable storage drive. A control module (in this example, software instructions or executable computer program code), when executed by the processor in the computer system, causes a processor to perform the functions of the invention as described herein.

Furthermore, the inventive concept can be applied to any circuit for performing signal processing functionality within a network element. It is further envisaged that, for example, a semiconductor manufacturer may employ the inventive concept in a design of a stand-alone device, such as a microcontroller of a digital signal processor (DSP), or application-specific integrated circuit (ASIC) and/or any other sub-system element.

It will be appreciated that, for clarity purposes, the above description has described embodiments of the invention with reference to a single processing logic. However, the inventive concept may equally be implemented by way of a plurality of different functional units and processors to provide the signal processing functionality. Thus, references to specific functional units are only to be seen as references to suitable means for providing the described functionality, rather than indicative of a strict logical or physical structure or organization.

Aspects of the invention may be implemented in any suitable form including hardware, software, firmware or any combination of these. The invention may optionally be implemented, at least partly, as computer software running on one or more data processors and/or digital signal processors or configurable module components such as FPGA devices.

Thus, the elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

While the present application has been described in connection with what is considered the most practical and preferred embodiments, it is understood that the present application is not limited to the disclosed embodiments but is intended to cover various arrangements made without departing from the scope of the broadest interpretation of the appended claims.

1-73. (canceled)

74. A method for small data transmission (SDT) in a power saving state, performed by a user equipment (UE) in a network, the method comprising:
receiving a SDT configuration in a radio resource control (RRC) signaling;
monitoring a downlink (DL) signaling including a mobile terminated (MT) indication in a physical downlink control channel (PDCCH) or paging occasion in the power saving state; and
upon reception of the MT indication, receiving DL small data on an associated radio resource based on the SDT configuration without RRC state transition,
wherein the DL small data are received based on a MT-SDT procedure using random access (RA)-based procedure or configured grant (CG)-based procedure as a baseline.

75. The method of claim 74, wherein the SDT configuration comprises DL/uplink (UL) common/UE-specific SDT configuration and/or random access channel (RACH) partition and resource configuration,
wherein in the case where the SDT configuration comprises the RACH partition and resource configuration, the receiving the SDT configuration in the RRC signaling comprises:
receiving the SDT configuration including RACH partition for SDT, wherein a preamble used in the random access-based procedure is selected from the RACH partition of the SDT configuration, and preamble partitioning is defined on a feature or feature combination basis, and a mapping between the feature or feature combination and an associated physical random access channel (PRACH) resource set has an association.

76. The method of claim 74, wherein the DL signaling is downlink control information (DCI), which comprises scheduling information for the DL small data.

77. The method of claim 76, wherein the DCI comprises a short message in which the MT indication is embedded.

78. The method of claim 74, wherein the MT indication is implemented via paging and included in a paging record field of a paging message, which is indicated by an inactive-radio network temporary identifier (I-RNTI).

79. The method of claim 78, wherein transmission of the DL small data is following the paging based on a configured MT-SDT period or offset.

80. The method of claim 74, wherein the SDT configuration comprises an information element (IE) which configures MT-SDT information, and the MT-SDT information comprises at least one of a priority rule or a threshold for the DL small data.

81. The method of claim 74, further comprising:
transmitting at least a subsequent UL or DL small data following completion of the initial transmission of the DL small data based on a SDT threshold.

82. The method of claim 74, wherein resource allocation of the MT-SDT is associated with a CG-SDT resource configuration.

83. The method of claim 82, wherein the resource allocation of the MT-SDT is associated with the CG-SDT resource configuration and is configured within a CG-SDT configuration IE comprised in the SDT configuration.

84. The method of claim 83, wherein MT-SDT radio resource is allocated before the assignment of CG-SDT resource.

85. The method of claim 83, wherein MT-SDT radio resource is allocated before the assignment of CG-SDT resource based on the CG-SDT and a configured MT-SDT period or offset.

86. The method of claim 74, wherein mobile originated (MO) data and MT data are transmitted via CG-SDT and MT-SDT procedures simultaneously.

87. The method of claim 74, wherein upon reception of the MT indication, the DL small data are received based on one or more SDT timers.

88. The method of claim 87, wherein the DL small data are received based on a MT-SDT timer, and the method further comprises:
starting the MT-SDT timer to wait for initial transmission of the DL small data after the reception of the MT indication; and
stopping the MT-SDT timer at completion of the reception of the DL small data.

89. The method of claim 87, wherein the monitoring step is performed when a SDT-time alignment timer (TAT) is running, wherein the UE needs to monitor PDCCH or paging for DL small data transmission, retransmission, system information change, or public warning indication.

90. The method of claim 87, wherein the monitoring step is performed only if a random access (RA)-SDT timer is not running but a SDT-TAT is running, wherein the SDT-TAT is used to manage time alignment and is restarted upon reception of a timing advance (TA) command.

91. A method for small data transmission (SDT) in a power saving state, performed by a base station (BS), the method comprising:
transmitting to a user equipment (UE) a SDT configuration in a radio resource control (RRC) signaling;
transmitting to the UE in the power saving state a downlink (DL) signaling including a mobile terminated (MT) indication in a physical downlink control channel (PDCCH) or paging occasion; and
based on the SDT configuration, transmitting DL small data on an associated radio resource without UE RRC state transition,
wherein the DL small data are transmitted based on a MT-SDT procedure using random access (RA)-based procedure or configured grant (CG)-based procedure as a baseline.

92. A user equipment (UE), comprising a memory and a processor coupled to the memory, the processor configured to call and run program instructions stored in a memory to execute the method of claim 74.

93. A base station (BS), comprising a memory and a processor coupled to the memory, the processor configured to call and run program instructions stored in a memory to execute the method of claim 91.
